(19) United States
(12) Patent Application Publication
(10) Pub. No.: US 2026/0242030 A1
(43) Pub. Date: Aug. 20, 2026

(54) BICYCLE STEM ASSEMBLY

(71) Applicant: J.D COMPONENTS CO., LTD., CHANG HUA HSIEN (TW)

(72) Inventors: CHUN-WEI HUANG, CHANG HUA HSIEN (TW); HSUEH-CHIEN HSIAO, CHANG HUA HSIEN (TW)

(21) Appl. No.: 19/540,078

(22) Filed: Feb. 13, 2026

(30) Foreign Application Priority Data
Feb. 19, 2025 (TW) 114201704

(51) Int. Cl. B62K 21/18; B62J 15/00; B62K 19/32; B62K 21/02; B62K 21/06; B62K 21/12; B62K 21/16; B62K 21/24

(52) U.S. Cl. CPC B62K 21/18; B62J 15/00; B62K 19/32; B62K 21/02; B62K 21/06; B62K 21/12; B62K 21/125; B62K 21/16; B62K 21/24

(57) ABSTRACT

A bicycle stem assembly includes a front fork tube having a tube body, a stem sleeved onto the tube body and having an upper abutting portion, an upper cover fastened to the stem and abutting against the upper abutting portion, and a decorative cover covering the upper cover. The upper cover includes upper engagement portions, and the decorative cover includes corresponding cover engaging portions for secure attachment. Alternatively, the front fork tube may include lower engagement portions, and the stem may include a transverse slot, through which tube engaging portions of the decorative cover engage with the lower engagement portions. Alternatively, the tube engaging portions of the decorative cover may engage directly with the tube body of the front fork tube through the transverse slot of the stem. With these configurations, the decorative cover can be conveniently mounted and securely retained.

### BACKGROUND OF THE INVENTION

### 1. Field of the Invention

The present invention relates to a bicycle and more particularly, to a bicycle stem assembly.

### 2. Description of the Related Art

In earlier known bicycle stem structures, a decorative cover is fastened to the stem by fixing members such as screws. Such a design not only requires a rider to carry tools for disassembly and assembly, but also results in issues including an increased number of components, complicated assembly procedures, and higher manufacturing costs.

In the bicycle stem assembly disclosed in TW M645488, the decorative cover is engaged with the stem by engagement protrusions on two sides of the decorative cover being engaged with engagement recesses on two sides of the stem, and the decorative cover is further engaged with a bottom of an upper cover by an engagement tab on an upper side thereof. However, vibrations or large shaking amplitudes of the stem during riding may easily cause the decorative cover to disengage. In addition, when the stem is subjected to an external impact, the engagement of the decorative cover may also be released. Furthermore, since the decorative cover does not entirely cover the upper cover, the upper cover is also susceptible to impact, which may further cause the decorative cover to disengage.

In the bicycle stem disclosed in TW M661879, an upper housing is fixed to the stem by a fastening member, and a cap is vertically mounted in a through hole of the upper housing. The cap is prone to popping out of the upper housing due to road bumps during riding, and the upper housing is also susceptible to external impacts that may cause the engagement of the cap to be released. Moreover, the cap does not cover the fastening member.

### SUMMARY OF THE INVENTION

In view of the foregoing, an objective of the present invention is to provide a bicycle stem assembly that allows a decorative cover to be engaged more conveniently, while ensuring that the decorative cover is engaged more securely.

To achieve the above-mentioned objective, the present invention provides a bicycle stem assembly comprising a front fork tube having a tube body; a stem having a hole sleeved onto the tube body of the front fork tube, and an upper abutting portion located around the hole; an upper cover having a lower abutting portion abutting against the upper abutting portion of the stem, a coupling hole configured for fastening the upper cover to the stem by a bolt, and two upper engagement portions located above the lower abutting portion; and a decorative cover having a cover body covering over the upper cover, and two cover engaging portions engaging with the upper engagement portions of the upper cover, respectively .

By virtue of the above technical features, the cover engaging portions of the decorative cover are engaged with the upper engagement portions of the upper cover, so that the decorative cover can be engaged more conveniently, and the engagement of the decorative cover is more secure.

Preferably, the upper cover may have an annular groove circumferentially formed above the lower abutting portion, and the upper engagement portions are formed by the annular groove. Accordingly, the engaging structure can be further simplified.

Preferably, the front fork tube may have two lower engagement portions formed from the tube body, the stem may have a transverse slot communicated with the hole of the stem , and the decorative cover may have two tube engaging portions extending through the transverse slot of the stem and engaging with the two lower engagement portions of the front fork tube. By virtue of the two tube engaging portions of the decorative cover engaging with the two lower engagement portions of the front fork tube, the decorative cover can be engaged more conveniently, and the engagement of the decorative cover is more secure.

Preferably, the stem may have a transverse slot communicated with the hole of the stem, and the decorative cover may have two tube engaging portions extending through the transverse slot of the stem and engaging with the tube body of the front fork tube. Accordingly, the engaging structure can be further simplified.

Preferably, the stem may have a longitudinal slot communicated with the hole of the stem, and the decorative cover may have a longitudinal rib inserted into the longitudinal slot of the stem. By virtue of the cooperation between the longitudinal slot and the longitudinal rib, lateral displacement of the decorative cover relative to the stem can be prevented.

Preferably, the decorative cover may comprise an object-mounting portion formed from the cover body. Accordingly, the decorative cover can be conveniently mount ed with other objects.

Preferably, the bicycle stem assembly may further comprise a bottom cover sleeved onto the tube body of the front fork tube. The decorative cover may have a first anti-disengagement portion, and the bottom cover may have a second anti-disengagement portion abutting against the first anti-disengagement portion of the decorative cover. Accordingly, the bottom cover can abut against and prevent the decorative cover from disengaging.

To achieve the above-mentioned objective, the present invention provides a bicycle stem assembly comprising a front fork tube having a tube body and two lower engagement portions formed from the tube body; a stem having a hole sleeved onto the tube body of the front fork tube, an upper abutting portion located around the hole, and a transverse slot communicated with the hole; an upper cover having a lower abutting portion abutting against the upper abutting portion of the stem, and a coupling hole configured for fastening the upper cover to the stem by a bolt; and a decorative cover having a cover body covering over the upper cover, and two tube engaging portions extending through the transverse slot of the stem and engaging with the two lower engagement portions of the front fork tube.

By virtue of the above technical features, the two tube engaging portions of the decorative cover are engaged with the two lower engagement portions of the front fork tube, so that the decorative cover can be engaged more conveniently, and the engagement of the decorative cover is more secure.

Preferably, the stem may have a longitudinal slot communicated with the hole of the stem, and the decorative cover may have a longitudinal rib inserted into the longitudinal slot of the stem. By virtue of the cooperation between the longitudinal slot and the longitudinal rib, lateral displacement of the decorative cover relative to the stem can be prevented.

Preferably, the decorative cover may comprise an object-mounting portion formed from the cover body. Accordingly, the decorative cover can be conveniently mount ed with other objects.

Preferably, the bicycle stem assembly may further compris e a bottom cover sleeved onto the tube body of the front fork tube . T he decorative cover may have a first anti-disengagement portion, and the bottom cover may have a second anti-disengagement portion abutting against the first anti-disengagement portion of the decorative cover. Accordingly, the bottom cover can abut against and prevent the decorative cover from disengaging.

To achieve the above-mentioned objective, the present invention provides a bicycle stem assembly comprising a front fork tube having a tube body; a stem having a hole sleeved onto the tube body of the front fork tube, and a transverse slot communicated with the hole; an upper cover having a coupling hole configured for fastening the upper cover to the stem by a bolt; and a decorative cover having a cover body covering over the upper cover, and two tube engaging portions extending through the transverse slot of the stem and engaging with the tube body of the front fork tube.

By virtue of the above technical features, the two tube engaging portions of the decorative cover are engaged with the tube body of the front fork tube, so that the decorative cover can be engaged more conveniently, and the engagement of the decorative cover is more secure.

Preferably, the stem may have a longitudinal slot communicated with the hole of the stem, and the decorative cover may have a longitudinal rib inserted into the longitudinal slot of the stem. By virtue of the cooperation between the longitudinal slot and the longitudinal rib, lateral displacement of the decorative cover relative to the stem can be prevented.

Preferably, the decorative cover may comprise an object-mounting portion formed from the cover body. Accordingly, the decorative cover can be conveniently mounted with other objects.

Preferably, the bicycle stem assembly may further comprise a bottom cover sleeved onto the tube body of the front fork tube. The decorative cover may have a first anti-disengagement portion, and the bottom cover may have a second anti-disengagement portion abutting against the first anti-disengagement portion of the decorative cover. Accordingly, the bottom cover can abut against and prevent the decorative cover from disengaging.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a first preferred embodiment of the present invention ;

FIG. 2 is an assembled sectional view of the first p referred embodiment of the present invention ;

FIG. 3 is a sectional view taken along line 3–3 in FIG. 2 ;

FIG. 4 is a sectional view taken along line 4–4 in FIG. 2 ;

FIG. 5 is a plan exploded sectional view of the first preferred embodiment of the present invention ;

FIG. 6 is a perspective exploded view of the first preferred embodiment of the present invention ;

FIG. 7 is another perspective exploded view of the first preferred embodiment of the present invention ;

FIG. 8 is still another perspective exploded view of the first preferred embodiment of the present invention ;

FIG. 9 is a perspective assembled view of a second preferred embodiment of the present invention ;

FIG. 10 is a perspective assembled view of a third preferred embodiment of the present invention ; and

FIG. 11 is a perspective assembled view of a fourth preferred embodiment of the present invention.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

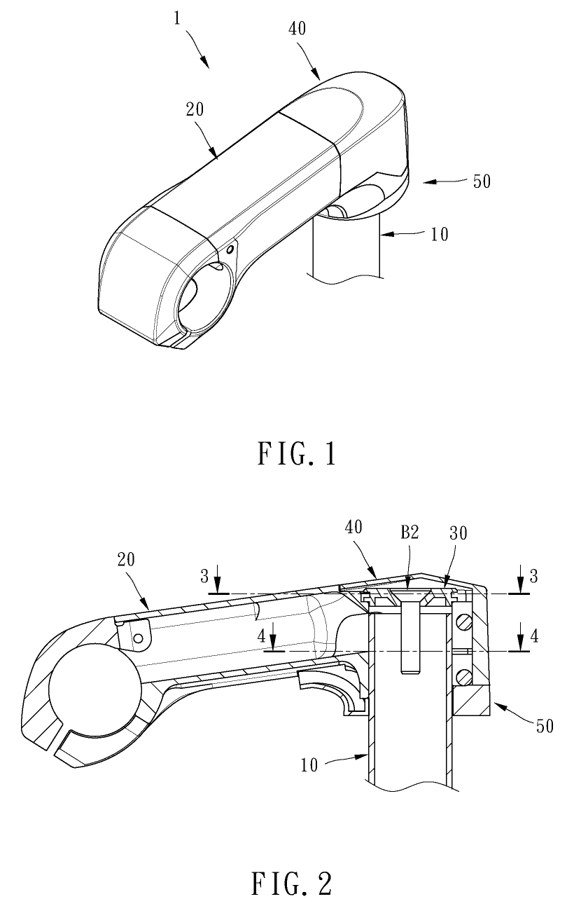

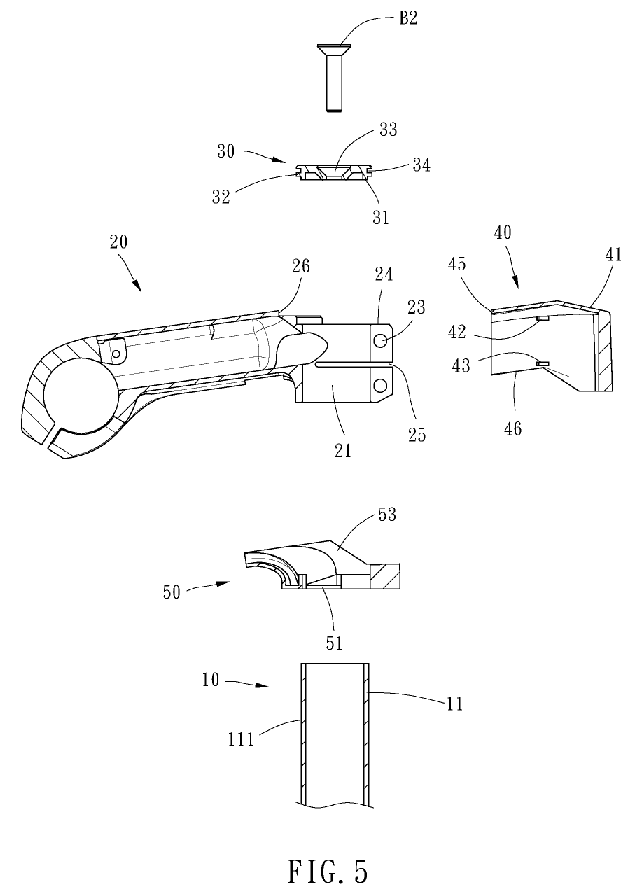

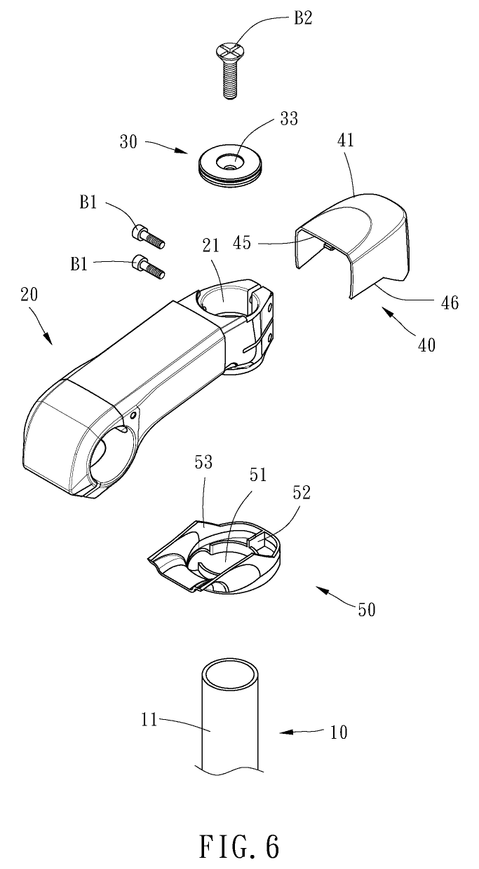

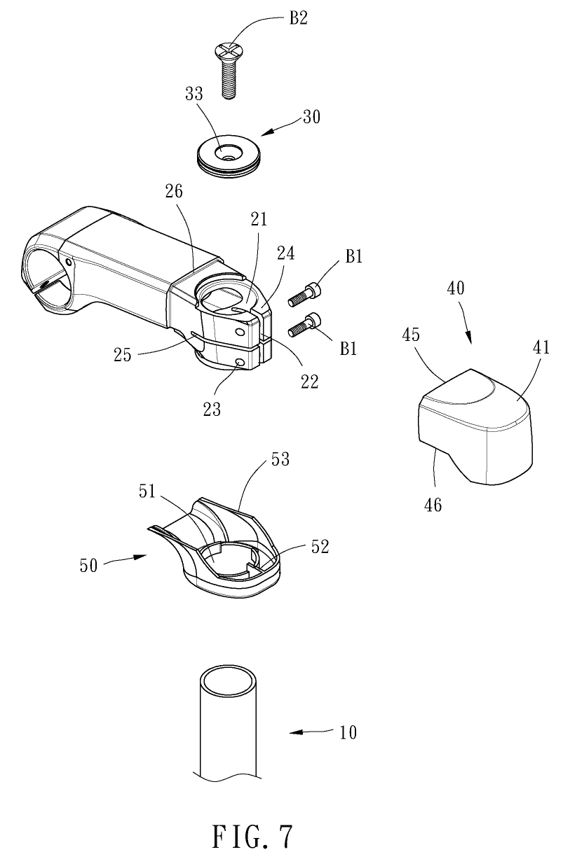

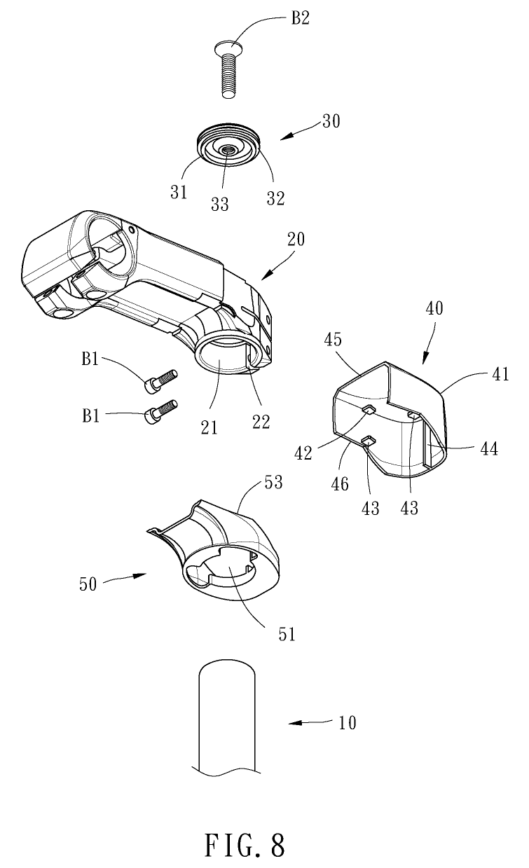

Referring to FIGS. 1 to 8, a first preferred embodiment of a bicycle stem assembly 1 of the present creation mainly comprises a front fork tube 10, a stem 20, an upper cover 30, a decorative cover 40, and a bottom cover 50.

The front fork tube 10 has a tube body 11 and two lower engagement portions 12 , as show in FIG. 4. The lower engagement portions 12 are formed by part or all of an outer periphery of the tube body 11.

The stem 20 has a hole 21, a longitudinal slot 22, a plurality of bolt holes 23, an upper abutting portion 24, a transverse slot 25, and a cover-abutting edge 26. The hole 21 is sleeved onto the tube body 11 of the front fork tube 10, the longitudinal slot 22 longitudinally communicates with the hole 21, and the bolt holes 23 are inserted with first bolts B1 , such that the stem 20 is secure d to the front fork tube 10. The upper abutting portion 24 is located around the hole 21 and above the bolt holes 23 , the transverse slot 25 laterally communicates with the hole 21, and the cover-abutting edge 26 is formed on one side of the upper abutting portion 24.

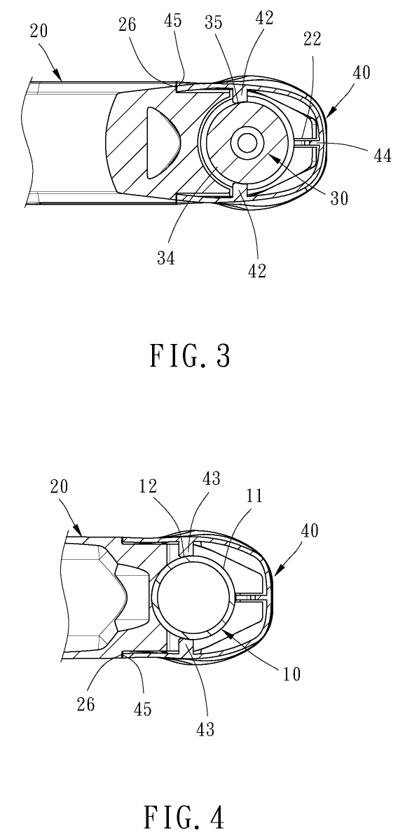

The upper cover 30 has a hole portion 31, a lower abutting portion 32, a coupling hole 33, an annular groove 34, and as shown in FIG. 3 two upper engagement portions 35. The hole portion 31 corresponds to the hole 21 of the stem 20, the lower abutting portion 32 abuts against the upper abutting portion 24 of the stem 20, and the coupling hole 33 is located at a central region of the lower abutting portion 32 and is inserted with a second bolt B2 to secure the upper cover 30 to the stem 20. The annular groove 34 is circumferentially formed above the lower abutting portion 32, and the upper engagement portions 35 are provided at the annular groove 34 . I n this embodiment, the upper engagement portions 35 are formed by part or all of the annular groove 34.

The decorative cover 40 has a cover body 41, two cover engaging portions 42, two tube engaging portions 43, a longitudinal rib 44, a front edge 45, and two first anti-disengagement portions 46. The cover body 41 covers over the upper cover 30 and on the stem 20. The cover engaging portions 42 are inserted into the annular groove 34 of the upper cover 30 to engage with the upper engagement portions 35. The tube engaging portions 43 extend through the transverse slot 25 of the stem 20 and slidably abut against the tube body 11 of the front fork tube 10 to engage with the lower engagement portions 12. The longitudinal rib 44 is inserted into the longitudinal slot 22 of the stem 20. The front edge 45 corresponds to the cover-abutting edge 26 of the stem 20. The first anti-disengagement portions 46 are provided at the bottom of the decorative cover 40.

The bottom cover 50 has a bottom cover hole 51 and a longitudinal rib 52. The bottom cover hole 51 is sleeved onto the front fork tube 10, such that the bottom cover 50 is located below the stem 20 and the decorative cover 40. Further, the longitudinal rib 52 is inserted into the longitudinal slot 22 of the stem 20, thereby preventing left-right movement of the bottom cover 50 and helping to prevent the bottom cover 50 from disengaging. In addition, the bottom cover 50 further has two second anti-disengagement portions 53 cooperating with the first anti-disengagement portions 46 of the decorative cover 40. The decorative cover 40 can be disengaged only when the bottom cover 50 is moved downward. The first anti-disengagement portions 46 and the second anti-disengagement portions 53 may be configured as chamfered edges, t enon and m ortise structure , or other coupling structures.

In this embodiment, by engaging the two cover engaging portions 42 of the decorative cover 40 with the upper engagement portions 35 of the upper cover 30, and engaging the two tube engaging portions 43 of the decorative cover 40 with the lower engagement portions 12 of the front fork tube 10, the decorative cover 40 can be quickly mounted with stable engagement and is not easily disengaged due to impact, thereby achieving the objective of the present creation. Further, by inserting the longitudinal rib 44 of the decorative cover 40 into the longitudinal slot 22 of the stem 20, lateral movement can be prevented and disengagement can be further avoided. Moreover, by providing the bottom cover 50 with the two second anti-disengagement portions 53 cooperating with the first anti-disengagement portions 46 of the decorative cover 40, the decorative cover 40 can be disengaged only when the bottom cover 50 is moved downward, which further helps prevent disengagement.

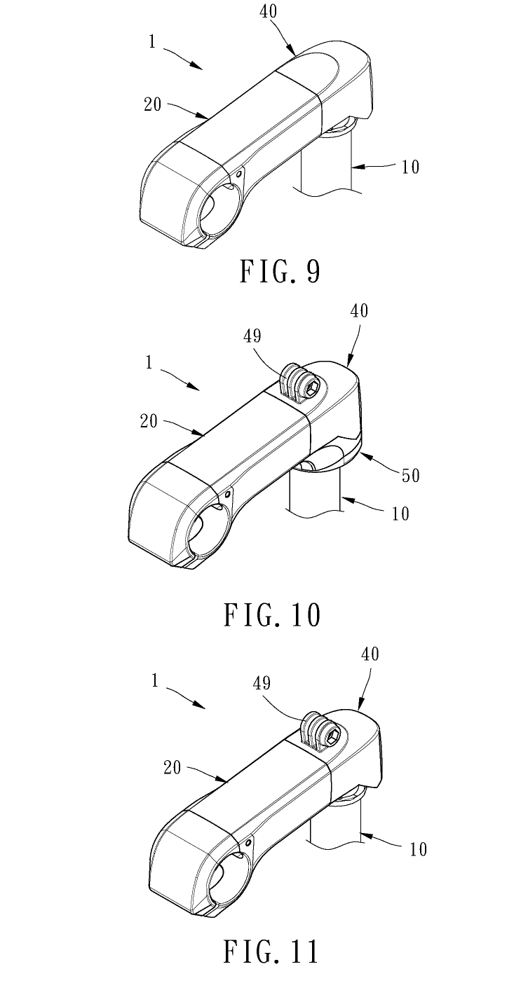

A s shown in FIG. 9 , a second preferred embodiment of the bicycle stem assembly 1 of the present creation is substantially the same as the foregoing embodiment, with the primary difference being that the bottom cover 50 may be omitted, while the objective of the present creation can still be achieved.

A s shown in FIGS. 10 and 11 , a third preferred embodiment and a fourth embodiment of the bicycle stem assembly 1 of the present creation are substantially the same as the foregoing embodiments, with the primary difference being that the decorative cover 40 further includes an object-mounting portion 49 provided at the top of the cover body 41 . The object -mounting portion may be realized as an object-mounting base or mounting hole for mounting objects such as a cyclometer or a display.

In addition to the above embodiments, the present invention may be modified and implemented as follows.

For example, in addition to the upper engagement portions 35 of the upper cover 30 being formed as part or all of the annular groove 34 as described above, the upper engagement portions 35 may alternatively be configured as recesses (not shown) or protrusions (not shown) for engagement with the cover engaging portions 42 of the decorative cover 40.

Alternatively, in addition to the lower engagement portions 12 of the front fork tube 10 being formed as part or all of the tube body 11 as described above, the lower engagement portions 12 may alternatively be configured as recesses (not shown) or protrusions (not shown) for engagement with the tube engaging portions 43 of the decorative cover 40. That is, the two tube engaging portions 43 of the decorative cover 40 may engage with the two lower engagement portions 12 of the front fork tube 10, or the two tube engaging portions 43 of the decorative cover 40 may engage directly with the tube body 11 of the front fork tube 10.

Alternatively, in addition to the decorative cover 40 including both the cover engaging portions 42 and the tube engaging portions 43 as described above, the decorative cover 40 may be configured to include only the cover engaging portions 42 without the tube engaging portions 43, or may be configured to include only the tube engaging portions 43 without the cover engaging portions 42.

In summary, the bicycle stem assembly 1 provided by the present invention employs a structure that allows the decorative cover 40 to be conveniently assembled and snap-fitted to the upper cover 30 and/or the front fork tube 10 without the use of any tools, thereby overcoming the drawbacks of the prior art in which the decorative cover requires complicated installation and removal procedures and must be installed using tools.

Finally, it should be noted that the constituent elements disclosed in the above embodiments of the present invention are only taken as examples for illustration, not intended to limit the scope of the present invention. The substitution or variation of other equivalent elements should be included within the scope of the following claims of the present invention.

What is claimed is:

1. A bicycle stem assembly, comprising:
a front fork tube having a tube body;
a stein having a hole sleeved onto the tube body of the front fork tube, and
an upper abutting portion located around the hole;an upper cover having a lower abutting portion abutting against the upper abutting portion of the stem, a coupling hole configured for fastening the upper cover to the stein by a bolt, and two upper engagement portions located above the lower abutting portion; and a decorative cover having a cover body covering over the upper cover, and
two cover engaging portions engaging with the upper engagement portions of the upper cover, respectively.

2. The bicycle stein assembly as claimed in claim 1, wherein the upper cover
has an annular groove circumferentially formed above the lower abutting portion, and the upper engagement portions are formed by the annular groove.

3. The bicycle stem assembly as claimed in claim 1, wherein the front fork tube has two lower engagement portions formed from the tube body, the stein has a transverse
slot communicated with the hole of the stem and the decorative cover has two tube engaging portions extending through the transverse slot of the stem and engaging with the two lower engagement portions of the front fork tube.

4. The bicycle stem assembly as claimed in claim 1, wherein the stem has a
transverse slot communicated with the hole of the stem, and the decorative cover has two
tube engaging portions extending through the transverse slot of the stem and engaging with the tube body of the front fork tube.

5. The bicycle stem assembly as claimed in claim 1, wherein the stem has a
longitudinal slot communicated with the hole of the stem, and the decorative cover has a longitudinal rib inserted into the longitudinal slot of the stem.

6. The bicycle stem assembly as claimed in claim 1, wherein the decorative cover comprises an object-mounting portion formed from the cover body.

7. The bicycle stem assembly as claimed in claim 1, further comprising a bottom cover sleeved onto the tube body of the front fork tube; wherein the decorative cover has a first anti-disengagement portion, and the bottom cover has a second anti- disengagement portion abutting against the first anti-disengagement portion of the
decorative cover.

8. A bicycle stem assembly, comprising:
a front fork tube having a tube body and two lower engagement portions formed from the tube body;
a stem having a hole sleeved onto the tube body of the front fork tube, an upper abutting portion located around the hole, and a transverse slot communicated with the hole;
an upper cover having a lower abutting portion abutting against the upper abutting portion of the stem, and a coupling hole configured for fastening the upper cover
to the stem by a bolt; and
a decorative cover having a cover body covering over the upper cover, and two tube engaging portions extending through the transverse slot of the stein and engaging with the two Lower engagement portions of the front forktube.

9. The bicycle stem assembly as claimed in claim 8, wherein the stem has a longitudinal slot communicated with the hole of the stem, and the decorative cover has a longitudinal rib inserted into the longitudinal slot of the stem.

10. The bicycle stein assembly as claimed in claim 8, wherein the decorative
cover comprises an object-mounting portion formed from the cover body.

11. The bicycle stem assembly as claimed in claim 8, further comprising a bottom cover sleeved onto the tube body of the front fork tube; wherein the decorative cover has a first anti-disengagement portion, and the bottom cover has a second anti-
disengagement portion abutting against the first anti-disengagement portion of the decorative cover.

12. A bicycle stem assembly, comprising:
a front fork tube having a tube body;
a stem having a hole sleeved onto the tube body of the front fork tube, and a transverse slot communicated with the hole;
an upper cover having a coupling hole configured for fastening the upper cover to the stem by a bolt; and
a decorative cover having a cover body covering over the upper cover, and two
tube engaging portions extending throughthe transverse slot of the stein and engaging
with the tube body of the front fork tube.

13. The bicycle stem assembly as claimed in claim 12, wherein the stemhas a longitudinal slot communicated with the hole of the stem and the decorative cover has a
longitudinal rib inserted into the longitudinal slot of the stem.

14. The bicycle stem assembly as claimed in claim 12, wherein the decorative cover comprises an object-mounting portion formed fromthe cover body.

15. The bicycle stem assembly as claimed in claim 12, further comprising a bottom cover sleeved onto the tube body of the front fork tube; wherein the decorative cover has a first anti-disengagement portion, and the bottom cover has a second anti- disengagement portion abutting against the first anti-disengagement portion of the decorative cover.
